(19) United States
(12) Patent Application Publication
(10) Pub. No.: US 2017/0308967 A1
(43) Pub. Date: Oct. 26, 2017

(54) "GAS-IN-O!" LIFE-TIME "FREE GAS" PROMOTION

(71) Applicant: Maxim CHIFRINE, Brooklyn, NY (US)

(72) Inventor: Maxim CHIFRINE, Brooklyn, NY (US)

(21) Appl. No.: 15/511,211

(22) PCT Filed: Sep. 7, 2014
(86) PCT No.: PCT/IB2014/064304

§ 371 Date: Mar. 21, 2017

(51) Int. Cl. G06Q 50/06; G06Q 20/18; G06Q 30/02

(52) U.S. Cl. CPC G06Q 50/06; G06Q 30/0237; G06Q 20/18; G06Q 30/0212

(57) ABSTRACT

The invention relates to the method and the system of life-time promotion for generating customer demand in gasoline and diesel and raising sales volume by driving more customer traffic to filling station location or to a network of branded filling stations independently to fluctuating of fuel prices and increasing of gasoline elasticity in the long run.

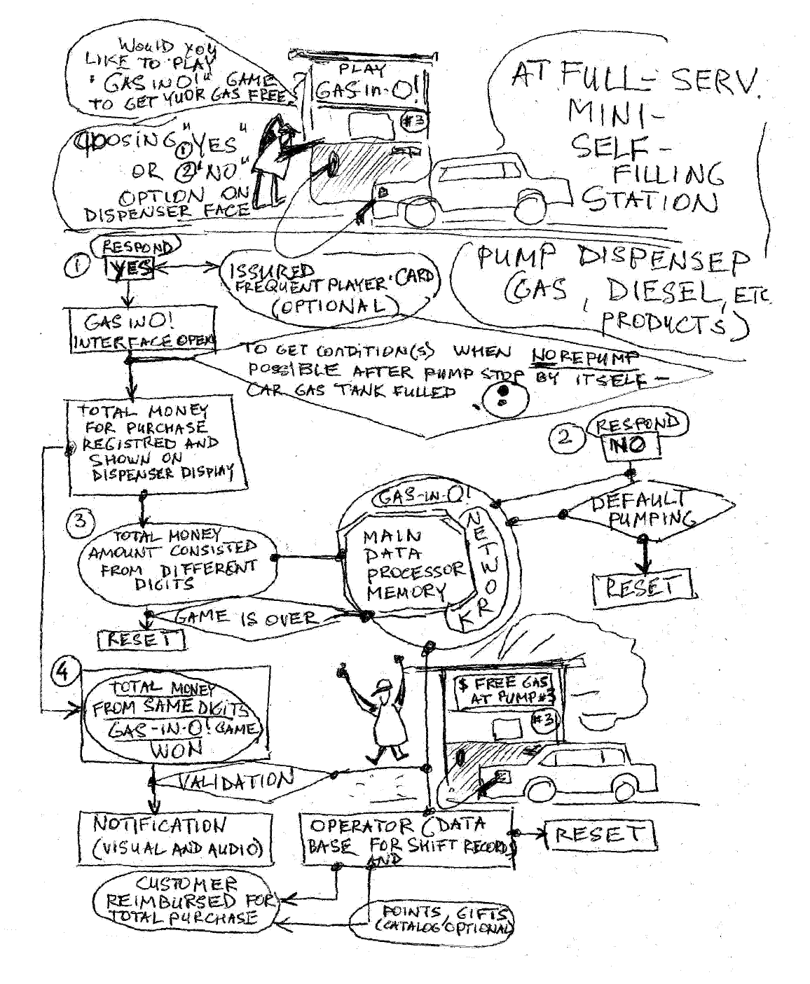

When the customer “fills up” his/her car′ fuel tank at involved in this promotion fuel station,
and after pump stopped by itself,
and with no re-pump, as settled at dispenser,
and the “total money” registered amount consists of THE SAME DIGITS: $22.22 or $111.11 or $7.77 or etc.
this fuel price amount pumped will be instantly reimbursed to this customer from the fuel station (gas station) operator.

In fact, this lucky customer received “FREE GAS” IN his/her car.

Notification of the “FREE GAS” IN is similar to a slot-machine Jackpot winner's notification—for example: “PUMP #3, $55.55 in FREE GAS!!!”—on video-screens with attracting sounds.

The lost of profits for reimbursements for “FREE GAS IN” together with expenses for design “GAS-in-O!” life-time promotion are mathematically incomparable with exploded traffic into the promoting business' location and rocket increase of sales value and profits.

1. What claimed is the method and the system of life-time promotion for generating customer demand in gasoline and diesel and raising sales volume by driving more customer traffic to filling station location or to a network of branded filling stations independently to fluctuating of fuel prices and increasing of gasoline elasticity in the long run.
